(19) United States
(12) Patent Application Publication
(10) Pub. No.: US 2016/0279458 A1
(43) Pub. Date: Sep. 29, 2016

(54) Elastic Cable Structure

(71) Applicant: Kun-Tan Kung, Taichung City (TW)

(72) Inventor: Kun-Tan Kung, Taichung City (TW)

(21) Appl. No.: 14/670,463

(22) Filed: Mar. 27, 2015

(51) Int. Cl. A63B 21/055; A01K 27/00

(52) U.S. Cl. CPC A63B 21/0555; A01K 27/003

(57) ABSTRACT

An elastic cable structure includes an elastic cable. The elastic cable includes a plurality of strands of elastic tubes, and the strands of elastic tubes are twisted mutually. Each of the elastic tubes includes an outer layer and a plurality of latex bars mounted in and covered by the outer layer. Thus, the latex bars are covered by the outer layer so that the latex bars will not directly contact the user's skin and will not cause allergic reactions to the user. In addition, the latex bars are completely covered by the outer layer so that when the latex bars are broken due to an excessive force, the latex bars are restricted by the outer layer and will not be sprung outward.

### BACKGROUND OF THE INVENTION

1. Field of the Invention

The present invention relates to a cord structure and, more particularly, to an elastic cable structure available for an elastic exercising device (such as a chest pull) or a pet drawing rope.

2. Description of the Related Art

A conventional elastic cable structure in accordance with the prior art shown in FIGS. 1 and 2 comprises an elastic cable 30, and two handles 40 mounted on two opposite ends of the elastic cable 30. Each of the two opposite ends of the elastic cable 20 is provided with locking members 32, and each of the handles 40 is provided with a mounting hole 41 for mounting the respective locking members 32 of the elastic cable 30. The elastic cable 30 includes a plurality of elastic ropes 31 which are twisted mutually. Each of the elastic ropes 31 is hollow and has a circular hole 311. Thus, the elastic cable 30 is fixed between the handles 40 so that the elastic cable structure functions as a chest pull. In fabrication, each of the elastic ropes 31 is generally made of thermoplastic rubber (TPR). However, the TPR is easily broken. Alternatively, each of the elastic ropes 31 is made of latex to enhance the lifetime thereof The latex is added with a chemical additive, such as a vulcanizer or curing agent, during the working process. However, the elastic ropes 31 are exposed so that the latex will directly contact the user's skin and will cause allergic reactions to the user. In addition, the elastic ropes 31 are exposed so that when one of the elastic ropes 31 is broken during a long-term utilization or due to an excessive force, the broken elastic rope 31 will be sprung outward and easily causes danger to the user.

### BRIEF SUMMARY OF THE INVENTION

In accordance with the present invention, there is provided an elastic cable structure comprising an elastic cable. The elastic cable includes a plurality of strands of elastic tubes, and the strands of elastic tubes are twisted mutually. Each of the elastic tubes includes an outer layer and at least one latex bar mounted in and covered by the outer layer.

Preferably, each of the strands of elastic tubes includes at least one elastic tube.

Preferably, each of the elastic tubes includes a plurality of latex bars, and the number of the latex bars is changed to fit a needed elastic force of the elastic cable.

Preferably, the outer layer of each of the elastic tubes is made by weaving.

Alternatively, the outer layer of each of the elastic tubes is made by stitching.

Preferably, the elastic cable structure further comprises two handles mounted on two opposite ends of the elastic cable. Each of the two opposite ends of the elastic cable is provided with a locking member, and each of the handles is provided with a mounting hole for mounting the respective locking member of the elastic cable.

Alternatively, the elastic cable structure further comprises a handle mounted on a first end of the elastic cable, and a locking hook mounted on a second end of the elastic cable and connected with a collar of a pet.

According to the primary advantage of the present invention, the latex bars enhance the tensile resistance, resilience and strength of the elastic cable.

According to another advantage of the present invention, the latex bars are covered by the outer layer so that the latex bars will not directly contact the user's skin and will not cause allergic reactions to the user.

According to a further advantage of the present invention, the outer layer has different colors to enhance the aesthetic quality of the elastic cable.

According to a further advantage of the present invention, the latex bars are completely covered by the outer layer so that when the latex bars are broken due to an excessive force, the latex bars are restricted by the outer layer and will not be sprung outward, so as to assure the user's safety of usage.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional elastic cable structure in accordance with the prior art.

FIG. 2 is a partially exploded perspective view of the conventional elastic cable structure as shown in FIG. 1.

FIG. 3 is a perspective view of an elastic cable structure in accordance with the preferred embodiment of the present invention.

FIG. 4 is a partially cut-away perspective enlarged view of the elastic cable structure as shown in FIG. 3.

FIG. 5 is a perspective cross-sectional view of the elastic cable structure as shown in FIG. 4, wherein the strands of elastic tubes are not twisted.

FIG. 6 is a cross-sectional view of an elastic tube.

FIG. 7 is a perspective view of an elastic cable structure in accordance with another preferred embodiment of the present invention.

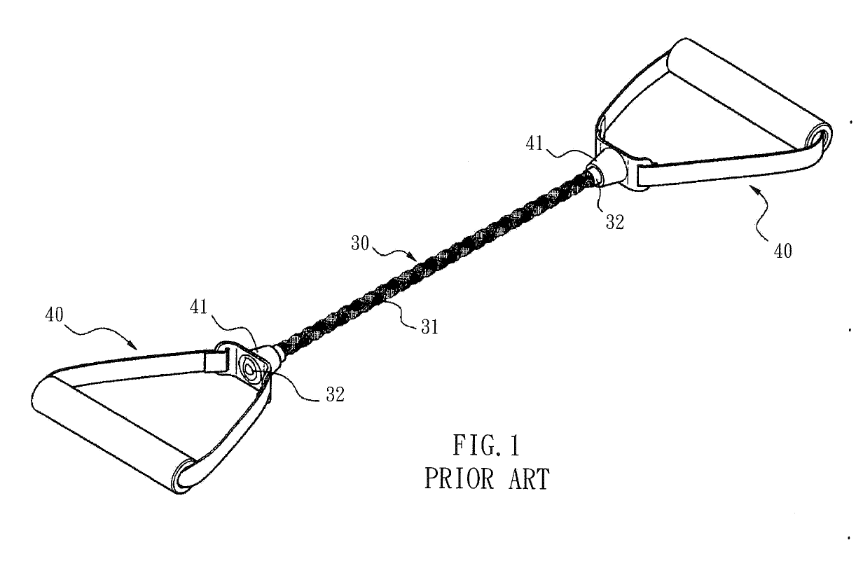

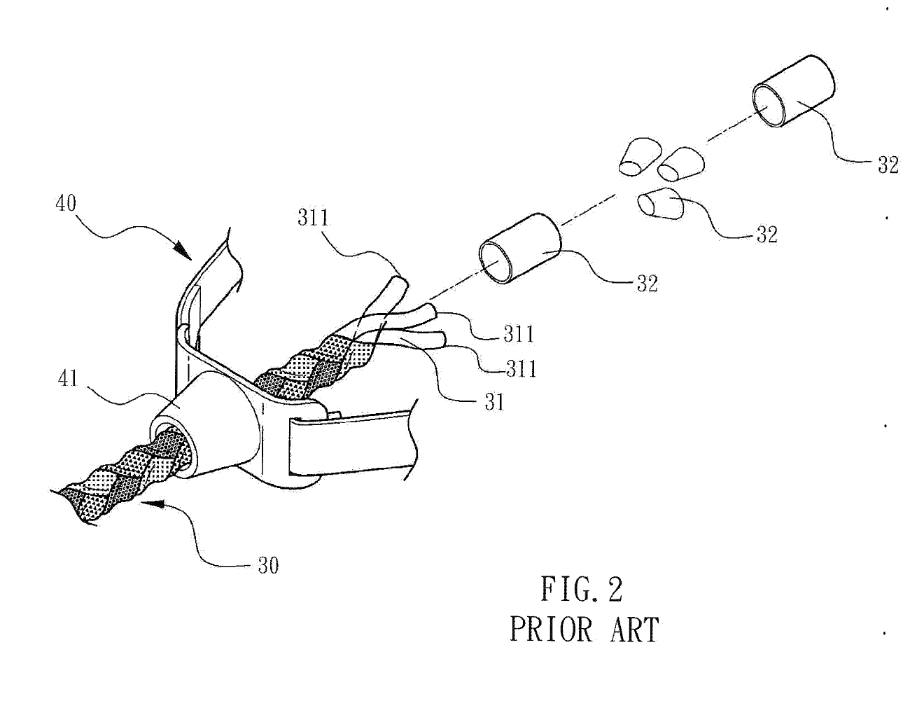

### DETAILED DESCRIPTION OF THE INVENTION

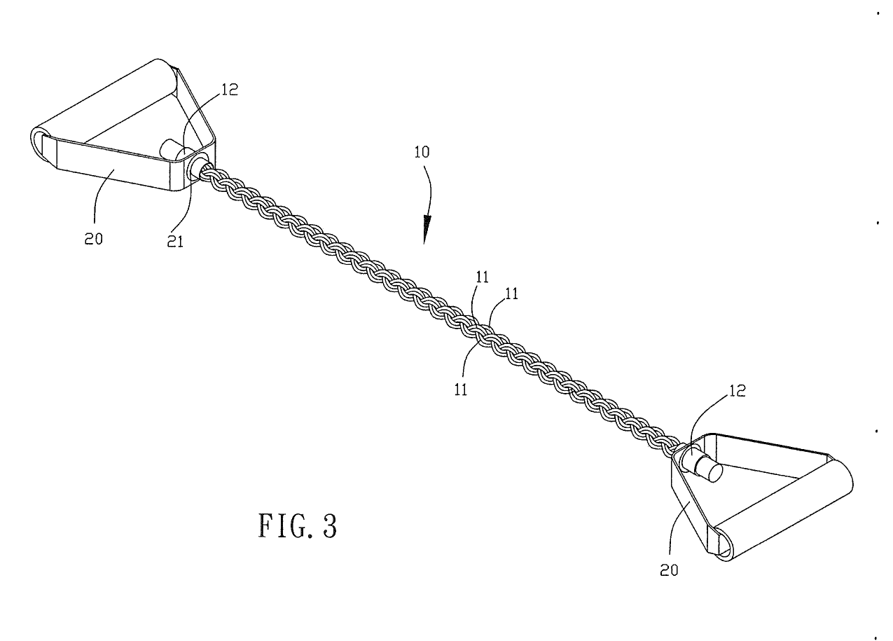

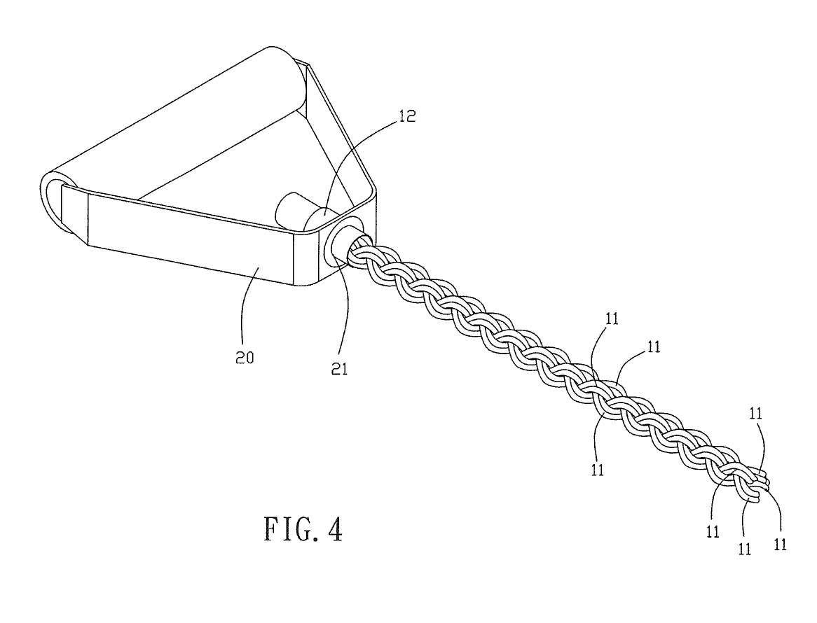

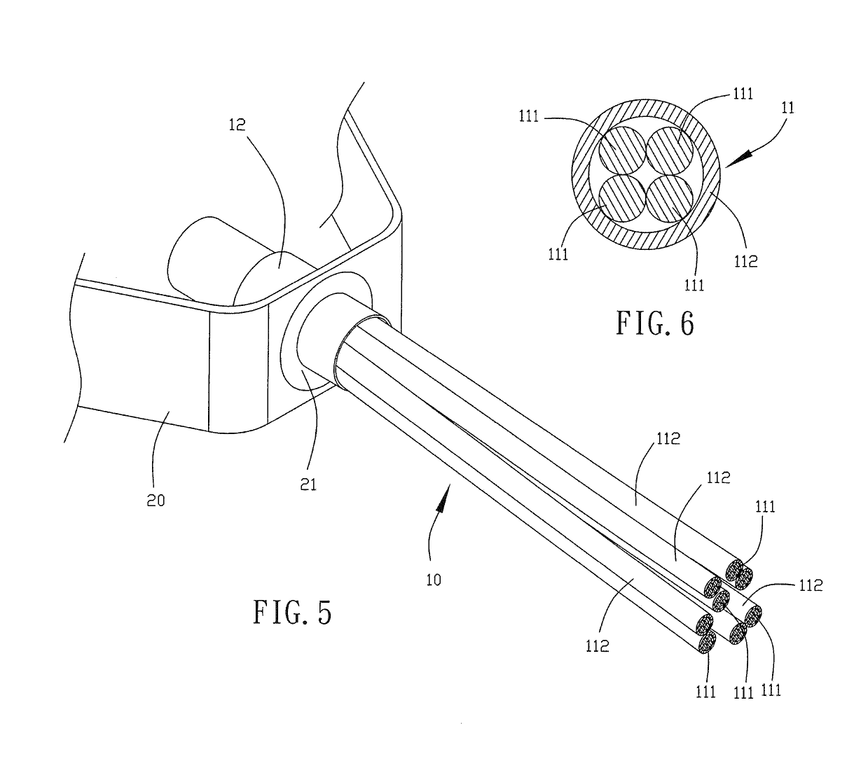

Referring to the drawings and initially to FIGS. 3-6, an elastic cable structure in accordance with the preferred embodiment of the present invention comprises an elastic cable 10, and two handles 20.

The elastic cable 10 includes a plurality of strands of elastic tubes 11, and the strands of elastic tubes 11 are twisted mutually. Each of the strands of elastic tubes 11 includes at least one elastic tube 11. Each of the elastic tubes 11 includes an outer layer 112 and at least one latex bar 111 mounted in and covered by the outer layer 112. Each of the elastic tubes 11 includes a plurality of latex bars 111, and the number of the latex bars 111 can be changed to fit the needed elastic force of the elastic cable 10 according to the user's requirement. The outer layer 112 of each of the elastic tubes 11 is preferably made by weaving or stitching.

In the preferred embodiment of the present invention, the elastic cable 10 includes four strands of elastic tubes 11, each of the strands of elastic tubes 11 includes two elastic tubes 11, and each of the elastic tubes 11 includes four latex bars 111.

The handles 20 are mounted on two opposite ends of the elastic cable 10. Each of the two opposite ends of the elastic cable 10 is provided with a locking member 12, and each of the handles 20 is provided with a mounting hole 21 for mounting the respective locking member 12 of the elastic cable 10.

In assembly, the outer layer 112 covers the latex bars 111 to form each of the elastic tubes 11. Then, a first end of the elastic cable 10 formed by the elastic tubes 11 is mounted in the respective locking member 12. Then, the elastic tubes 11 are divided into four strands, and the four strands of elastic tubes 11 are twisted mutually to form the elastic cable 10. Then, a second end of the elastic cable 10 is mounted in the respective locking member 12. Finally, the locking member 12 of each of the two opposite ends of the elastic cable 10 is mounted in the mounting hole 21 of each of the handles 20, so that the elastic cable 10 is fixed between the handles 20. Thus, the elastic cable structure functions as a chest pull.

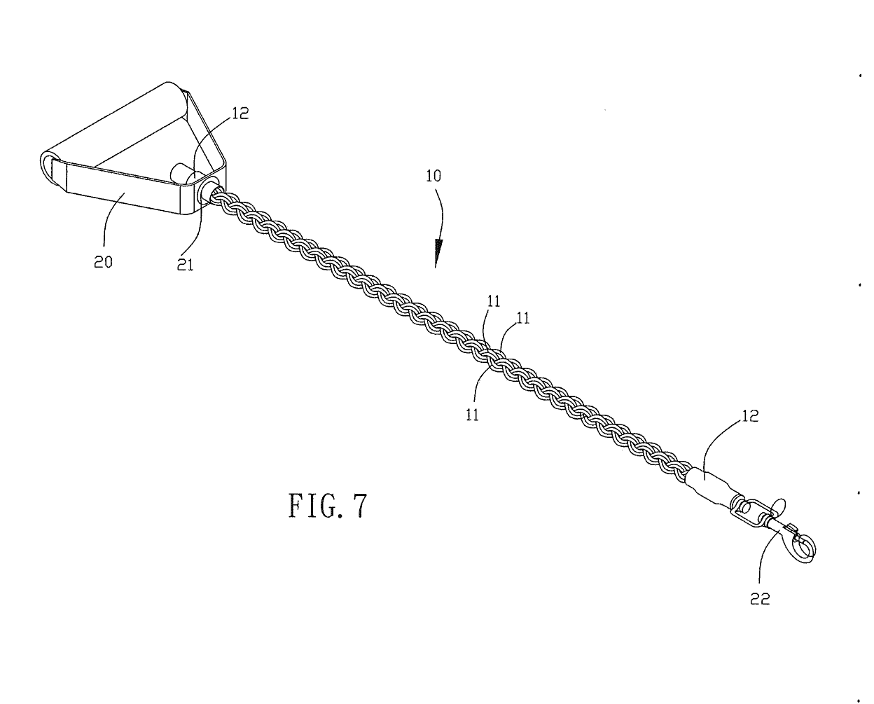

Referring to FIG. 7, one of the handles 20 is replaced by a locking hook 22 which is connected with a collar of a pet. Thus, the elastic cable structure functions as a pet drawing rope.

Accordingly, the latex bars 111 enhance the tensile resistance, resilience and strength of the elastic cable 10. In addition, the latex bars 111 are covered by the outer layer 112 so that the latex bars 111 will not directly contact the user's skin and will not cause allergic reactions to the user. Further, the outer layer 112 has different colors to enhance the aesthetic quality of the elastic cable 10. Further, the latex bars 111 are completely covered by the outer layer 112 so that when the latex bars 111 are broken due to an excessive force, the latex bars 111 are restricted by the outer layer 112 and will not be sprung outward, so as to assure the user's safety of usage.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An elastic cable structure comprising:
an elastic cable;
wherein:
the elastic cable includes a plurality of strands of elastic tubes, and the strands of elastic tubes are twisted mutually; and
each of the elastic tubes includes an outer layer and at least one latex bar mounted in and covered by the outer layer.

2. The elastic cable structure of claim 1, wherein each of the strands of elastic tubes includes at least one elastic tube.

3. The elastic cable structure of claim 1, wherein each of the elastic tubes includes a plurality of latex bars, and the number of the latex bars is changed to fit a needed elastic force of the elastic cable.

4. The elastic cable structure of claim 1, wherein the outer layer of each of the elastic tubes is made by weaving.

5. The elastic cable structure of claim 1, wherein the outer layer of each of the elastic tubes is made by stitching.

6. The elastic cable structure of claim 1, further comprising:
two handles mounted on two opposite ends of the elastic cable;
wherein:
each of the two opposite ends of the elastic cable is provided with a locking member; and
each of the handles is provided with a mounting hole for mounting the respective locking member of the elastic cable.

7. The elastic cable structure of claim 1, further comprising:
a handle mounted on a first end of the elastic cable; and
a locking hook mounted on a second end of the elastic cable and connected with a collar of a pet.
